(19) United States
(12) Patent Application Publication
(10) Pub. No.: US 2018/0350157 A1
(43) Pub. Date: Dec. 6, 2018

(54) PARKING MANAGEMENT SYSTEM, PARKING MANAGEMENT METHOD, AND NON-TRANSITORY COMPUTER READABLE MEDIUM STORING PROGRAM CAUSING COMPUTER TO EXECUTE PROCESSING

(71) Applicant: TOYOTA JIDOSHA KABUSHIKI KAISHA, Toyota-shi (JP)

(72) Inventors: Jun KOREISHI, Toyota-shi (JP); Daiki YOKOYAMA, Toyota-shi (JP)

(73) Assignee: TOYOTA JIDOSHA KABUSHIKI KAISHA, Toyota-shi (JP)

(21) Appl. No.: 15/986,405

(22) Filed: May 22, 2018

(30) Foreign Application Priority Data
May 31, 2017 (JP) 2017-107285

(51) Int. Cl. G07B 15/02; G06Q 10/02

(52) U.S. Cl. CPC G07B 15/02; G06Q 2240/00; G06Q 10/02

(57) ABSTRACT

A parking management system includes a processor configured to perform operations. The operations includes: receiving information on illegal parking in a first parking space which is reserved for use; searching for a parkable second parking space as an alternative for the first parking space based on the information on the illegal parking; and transmitting information on the second parking space to a device on which the reservation for use is made, or a device that is registered in advance.

### INCORPORATION BY REFERENCE

The disclosure of Japanese Patent Application No. 2017-107285 filed on May 31, 2017 including the specification, drawings and abstract is incorporated herein by reference in its entirety.

### BACKGROUND

### 1. Technical Field

The present disclosure relates to a parking management system, a parking management method, and a non-transitory computer readable medium storing a program causing a computer to execute processing.

### 2. Description of Related Art

A computer system that manages parking of vehicles in a parking lot is known. A parking management system that enables making a reservation for using a parking lot through the Internet is disclosed in Japanese Patent No. 4223757 (JP 4223757 B).

### SUMMARY

In the related art, when a parking lot that is to be used in compliance with reservation details registered in advance is illegally used without complying with the reservation details, a user having a reservation may not be able to use the parking lot in compliance with the reservation details.

The present disclosure provides a technology that enables a user having a reservation in a parking lot to use the parking lot even when the parking lot is illegally used.

A first aspect of the present disclosure relates to a parking management system including a processor configured to perform the operations. The operations includes: receiving information on illegal parking in a first parking space which is reserved for use; searching for a parkable second parking space as an alternative for the first parking space based on the information on the illegal parking; and transmitting information on the second parking space to a device on which the reservation for use is made, or a device that is registered in advance.

In the parking management system according to the first aspect of the present disclosure, in the operation of searching, the processor may search for the second parking space based on a distance from the first parking space.

In the parking management system according to the first aspect of the present disclosure, in the operation of searching, the processor may search for the second parking space of which the distance from the first parking space is less than a predetermined distance, and determine whether the second parking space is reservable in a reserved time period of the first parking space.

In the parking management system according to the first aspect of the present disclosure, in the operation of searching, the processor may search for the second parking space based on a distance from a destination of a user who has the reservation for the first parking space.

In the parking management system according to the first aspect of the present disclosure, in the operation of searching, the processor may search for the second parking space of which the distance from the destination of the user having the reservation for the first parking space is less than a predetermined distance, and determine whether the second parking space is reservable in a reserved time period of the first parking space.

In the parking management system according to the first aspect of the present disclosure, in the operation of searching, the processor may search for the second parking space based on an attribute of a parking space.

In the parking management system according to the first aspect of the present disclosure, in the operation of searching, the processor may execute the search for the second parking space a predetermined number of times, and select the second parking space as an alternative parking space based on a distance from a destination and easiness of parking in the parking space.

A second aspect of the present disclosure relates to a parking management method implemented in an information processing device including a processor. The parking management method includes, by the processor, receiving information on illegal parking in a first parking space which is reserved for use, by the processor, searching for a parkable second parking space as an alternative for the first parking space based on the information on the illegal parking, and by the processor, transmitting information on the second parking space to a device on which the reservation for use is made, or a device that is registered in advance.

The parking management method according to the second aspect of the present disclosure may further include, by the processor, operating a camera to capture an image of the first parking space and reading identification information on the first parking space in accordance with an instruction from the outside. The parking management method according to the second aspect of the present disclosure may further include, by the processor, comparing information on the reservation for using the first parking space with the identification information on the first parking space and receiving identification information on a vehicle illegally parked in the first parking space imaged by the camera when the information on the reservation for using the first parking space matches the identification information on the first parking space.

A third aspect of the present disclosure relates to a non-transitory computer readable medium storing a program causing a computer to execute processing. The program includes steps of receiving information on illegal parking in a first parking space which is reserved for use, searching for a parkable second parking space as an alternative for the first parking space based on the information on the illegal parking, and transmitting information on the second parking space to a device on which the reservation for use is made, or a device that is registered in advance.

A fourth aspect of the present disclosure relates to a parking management system including a server device with which reservation information on one or a plurality of parking spaces is registered, and a mobile terminal. The server device includes a first controller. The mobile terminal includes a communication unit that communicates with an external device, a camera that captures an image of a parking space and a vehicle parked in the parking space and acquires the captured image, and a second controller configured to acquire information on the parking space and identification information on the vehicle parked in the parking space from the image. The second controller is configured to acquire the reservation information on the parking space from the server device through a communication network, compare the reservation information with the identification information on the vehicle, determine that illegal parking is performed when there is inconsistency in the comparison, and transmit information on the illegal parking to the server device. The first controller is configured to search for a parkable second parking space, based on the information on the illegal parking, as an alternative for the first parking space that is a parking space in which the second controller determines that the illegal parking is performed, and transmit information on the second parking space to the mobile terminal or a device that is used when a reservation for using the first parking space is made.

According to the aspects of the present disclosure, it is possible to provide a technology that enables a user having a reservation in a parking lot to use the parking lot even when the parking lot is illegally used.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a schematic configuration of a parking management system according to one embodiment;

FIG. 2 is a diagram illustrating an example of a functional configuration of a mobile terminal according to one embodiment;

FIG. 3 is a diagram illustrating an example of a parking space according to one embodiment;

FIG. 4 is a diagram illustrating an example of a functional configuration of a server device according to one embodiment;

FIG. 5 is a flowchart illustrating an example of a process flow in the parking management system according to one embodiment;

FIG. 6 is a flowchart illustrating an example of a process flow in the parking management system according to one embodiment;

FIG. 7 is a flowchart illustrating an example of a process flow in the parking management system according to one embodiment;

FIG. 8 is a flowchart illustrating an example of a process flow in the parking management system according to one embodiment;

FIG. 9 is a flowchart illustrating an example of a process flow in the parking management system according to one embodiment;

FIG. 10 is a flowchart illustrating an example of a process flow in the parking management system according to one embodiment;

FIG. 11 is a flowchart illustrating an example of a process flow in the parking management system according to one embodiment;

FIG. 12 is a flowchart illustrating an example of a process flow in the parking management system according to one embodiment; and

FIG. 13 is a flowchart illustrating an example of a process flow in the parking management system according to one embodiment.

### DETAILED DESCRIPTION OF EMBODIMENTS

Hereinafter, an embodiment of the present disclosure will be specifically described with reference to the drawings. The scope of the disclosure is not limited to the embodiment.

### 1. HARDWARE CONFIGURATION

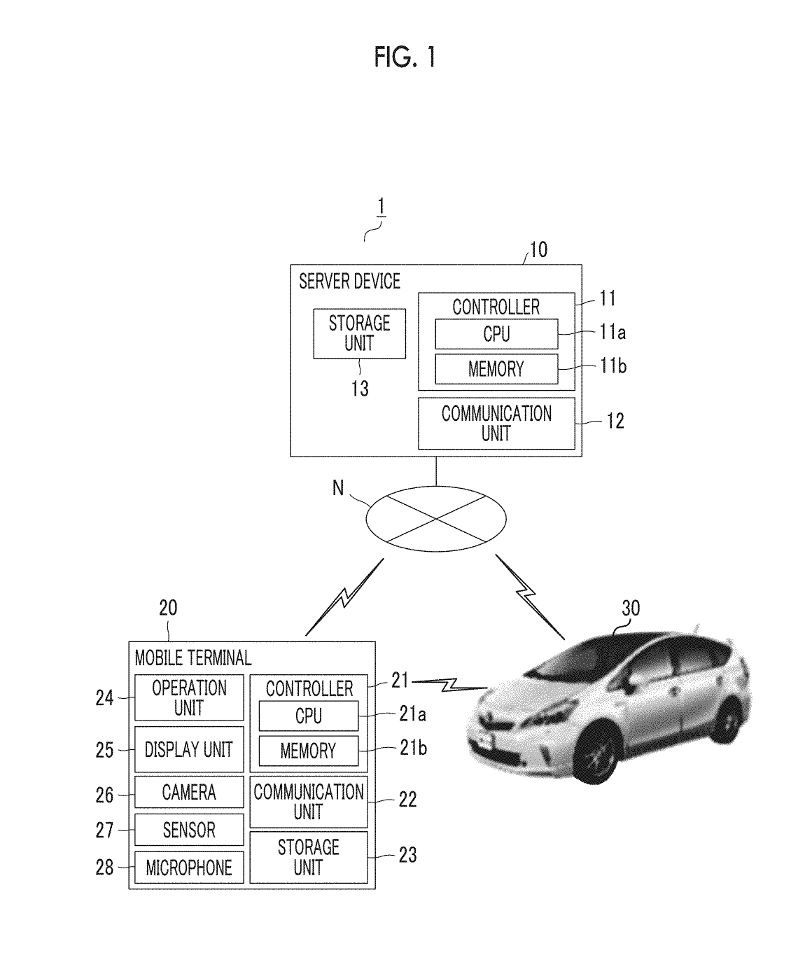

An example of a hardware configuration of a parking management system according to one embodiment will be described with reference to FIG. 1. A parking management system 1 is a computer system for managing parking (entry and exit) of vehicles in a parking lot. The parking management system 1 mainly includes a server device 10, a mobile terminal 20, and a vehicle 30. The mobile terminal 20 and the vehicle 30 can communicate with the server device 10 through a network N. The mobile terminal 20 can communicate with the vehicle 30 (using Bluetooth®, Wi-Fi®, and the like). The parking management system 1 can provide a user and an owner of the parking lot with various services for managing parking of the vehicle 30 driven by the user carrying the mobile terminal 20 in the parking lot.

While the parking management system 1 illustrated in FIG. 1 includes one mobile terminal 20 and one vehicle 30, the parking management system 1 can include a plurality of mobile terminals 20 and a plurality of vehicles 30.

The network N is a communication line for transmitting and receiving information among the server device 10, the mobile terminal 20, and the vehicle 30. For example, the network N may be the Internet, a packet communication network, a telephone line, or other communication lines, or a combination thereof. The network N may be configured either in a wired manner or a wireless manner (or a combination thereof).

The server device 10 is configured with an information processing device such as a dedicated or general-purpose computer. The server device 10 may be configured with a single information processing device or may be configured with a plurality of information processing devices distributed on the network.

The server device 10 mainly includes a controller 11, a communication unit 12, and a storage unit 13. The controller 11 is configured to mainly include a central processing unit (CPU) 11a and a memory 11b. Each configuration will be described below. For example, the server device 10 functions as means for implementing various functions by causing the CPU 11a to execute a predetermined program stored in the memory 11b and the like. In addition to the main configurations of the server device 10 illustrated in FIG. 1, the server device 10 includes other configurations included in a general information processing device.

The controller 11 controls the operation of various configurations and controls execution of various processes in the server device 10. A specific example of processes executed in the controller 11 will be described below. The communication unit 12 is a communication interface for communicating with external devices. The storage unit 13 is configured with a storage device such as a hard disk. The storage unit 13 stores various programs, various parameters, and information on the initial values of the various parameters needed for executing processes in the server device 10. For example, the programs and the parameters stored in the storage unit 13 are read, loaded into the memory 11b, and used in execution of various processes under control of the CPU 11a.

The mobile terminal 20 is a mobile information processing device (mobile terminal device) such as a mobile phone (including a smartphone), a tablet terminal, a personal digital assistant (PDA), a navigation device, and a personal computer. The mobile terminal 20 is configured to mainly include a controller 21, a communication unit 22, a storage unit 23, an operation unit 24, a display unit 25, a camera 26, a sensor 27, and a microphone 28. The controller 21 is configured to mainly include a CPU 21a and a memory 21b. For example, the mobile terminal 20 functions as means for implementing various functions by causing the CPU 21a to execute a predetermined program stored in the memory 21b and the like.

The controller 21 controls the operation of various configurations and controls execution of various processes in the mobile terminal 20. A specific example of processes executed in the controller 21 will be described below. The communication unit 22 is a communication interface for communicating with external devices. The storage unit 23 is configured with a storage device such as a semiconductor storage unit. The storage unit 23 stores various programs, various parameters, and information on the initial values of the various parameters needed for executing processes in the mobile terminal 20. For example, the programs and the parameters stored in the storage unit 23 are read, loaded into the memory 21b, and used in execution of various processes under control of the CPU 21a. The operation unit 24 is a user interface for receiving operation instructions from the user. The display unit 25 is a user interface for displaying process results of the mobile terminal 20. The camera 26 is a device that can capture a stationary image or a moving image.

The sensor 27 is configured with various sensors. The sensor 27 may include at least one of a gyro sensor, an acceleration sensor, a geomagnetic sensor, an audio sensor, or the like. The microphone 28 is a device that acquires audio information by converting a voice/sound of the user equipped with the mobile terminal 20 into an electrical signal.

The vehicle 30 is any vehicle that may be parked in the parking lot. The user carrying the mobile terminal 20 is present in the vehicle 30. The vehicle 30 further includes configurations (an internal combustion engine, a transmission, and the like) included in a general vehicle.

In the present embodiment thus far, the parking management system 1 includes the server device 10, the mobile terminal 20, and the vehicle 30. However, the parking management system 1 is not limited thereto and can include any device. In the parking management system 1, the mobile terminal 20 can include the function of the server device 10 such that the mobile terminal 20 performs processes such as directly receiving information from the parking lot, determining illegal parking, directly receiving information from other parking lots, and searching for an alternative parking lot. In such a case, the server device 10 is not needed.

### 2. FUNCTIONAL CONFIGURATION

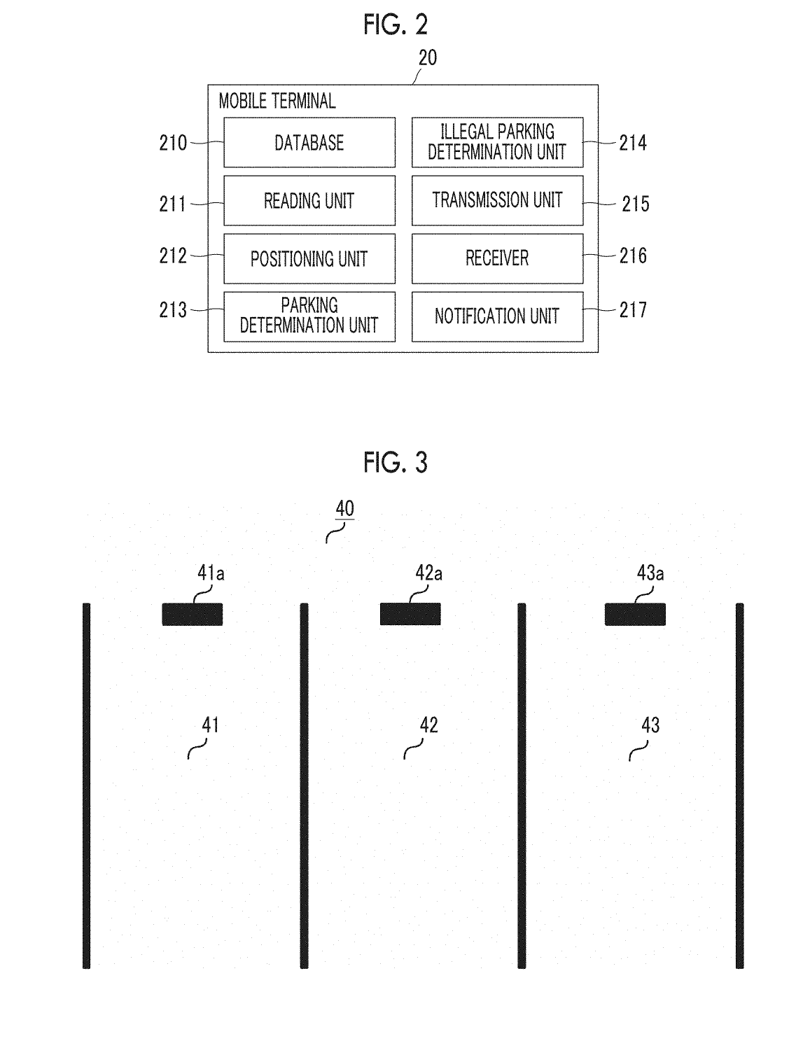

An example of a functional configuration of each device included in the parking management system according to one embodiment will be described. First, a functional configuration of the mobile terminal 20 will be described with reference to FIG. 2. While FIG. 1 illustrates a hardware configuration of the mobile terminal 20, FIG. 2 illustrates a functional configuration of the mobile terminal 20. As illustrated in FIG. 2, the mobile terminal 20 includes, as a main functional configuration, a database 210, a reading unit 211, a positioning unit 212, a parking determination unit 213, an illegal parking determination unit 214, a transmission unit 215, a receiver 216, and a notification unit 217. For example, the mobile terminal 20 implements each functional configuration illustrated in FIG. 2 by causing the CPU 21a to execute a predetermined program stored in the memory 21b and the like in cooperation with the hardware of the mobile terminal 20. For example, at least a part of the predetermined program (for example, a program for implementing the reading unit 211, the parking determination unit 213, and the illegal parking determination unit 214) is downloaded and installed on the mobile terminal 20 by a user operation. Hereinafter, each functional configuration will be specifically described.

The database 210 stores various types of information such as information needed for processes executed in the mobile terminal 20 and information generated by the processes. The various types of information include user information such as a user ID of the mobile terminal 20, and data of an application program installed on the mobile terminal 20.

The reading unit 211 reads various types of information from an image captured by the camera 26. For example, the reading unit 211 can read position information associated with each parking space (identification information on each parking space) from a code that is recognized through the image of parking spaces captured by the camera 26. In such a case, a two-dimensional code (two-dimensional code image) such as a Chameleon code® and a QR code® is disposed in each parking space in the parking lot. When the user operates the mobile terminal 20 to capture an image of the two-dimensional code using the camera 26, the reading unit 211 can read (acquire) the identification information on each parking space from the code image acquired by the camera 26. The code disposed in each parking space includes the coded position information (or the identification information on each parking space) for each parking space where the code is disposed. Accordingly, the reading unit 211 can read the position information or the identification information on each parking space from the code associated with each parking space.

An example of the code disposed in each parking space will be described with reference to FIG. 3. A parking lot 40 is illustrated in FIG. 3. The parking lot 40 includes parking spaces 41, 42, 43, and two-dimensional codes 41a, 42a, 43a are disposed in association with the parking spaces respectively. Information (for example, the position information on each parking space) for identifying the parking space 41, 42, or 43 is coded in each of the two-dimensional codes 41a, 42a, 43a. For example, when the user of the mobile terminal 20 who enters the parking space 41 by the vehicle 30 captures an image of the two-dimensional code 41a using the camera 26 of the mobile terminal 20, the reading unit 211 can acquire information on the parking space 41 (for example, the position information on the parking space 41) from the image of the two-dimensional code 41a.

While the two-dimensional codes 41a, 42a, 43a are disposed in association with the parking spaces respectively in the example in FIG. 3, the present disclosure is not limited thereto. Each of the two-dimensional codes 41a, 42a, 43a may be disposed in a supporting member such as a pylon and a pole disposed in each parking space. However, since the pylon or the pole is easily moved, there is a possibility that a valid position where the pylon or the pole should be disposed is not known. Accordingly, although not particularly limited, it is desirable to dispose the two-dimensional code in a place that is not easily moved. The code that is disposed in association with each parking space may not be the two-dimensional code and can employ any type of code such as a one-dimensional code and a three-dimensional code.

FIG. 2 will be referred to again. The reading unit 211 can also read the identification information on a vehicle from an image including the identification information on a vehicle such as an image of a license plate of a vehicle captured by the camera 26. For example, when the user of the mobile terminal 20 finds parking of a vehicle in a parking space that does not comply with reservation details, the user reads the identification information on the vehicle using the reading unit 211 in order to provide a notification of information on the parking as information on illegal parking. A method and a flow of process for providing a notification of illegal parking will be specifically described below. When the image of the parking space and the image of the license plate of the vehicle are included in one image captured by the camera 26, the reading unit 211 can read the identification information on the parking space and the identification information on the vehicle from the one image.

The positioning unit 212 performs a process of specifying the position (for example, the latitude and the longitude) of the mobile terminal 20 (host device) and also specifying the date and time when the position is specified (that is, specifying positioning information) based on signals that the mobile terminal 20 receives from a global positioning system (GPS) satellite and a communication device (for example, a base station).

The parking determination unit 213 can determine the start of parking and the end of parking of the vehicle 30 in the parking lot 40. For example, the parking determination unit 213 can determine the start of parking and the end of parking of the vehicle 30 in the parking lot 40 based on the position of the mobile terminal 20 specified by the positioning unit 212 and the result of sensing performed by the sensor 27 (the state of the mobile terminal 20 or the state of the user of the mobile terminal 20). Specifically, the parking determination unit 213 can determine that parking of the vehicle 30 is started when the position of the mobile terminal 20 specified by the positioning unit 212 is present in the parking lot 40, and the sensor 27 senses that the mobile terminal 20 is set to a state other than an in-vehicle state from the in-vehicle state (movement by vehicle). The parking determination unit 213 can determine that parking of the vehicle 30 is ended when the position of the mobile terminal 20 specified by the positioning unit 212 is in the parking lot 40, and the sensor 27 senses that the mobile terminal 20 is set to the in-vehicle state (movement by vehicle) from a state other than the in-vehicle state.

The parking determination unit 213 can determine the state of the user of the mobile terminal 20 (for example, a stationary state, the in-vehicle state (movement by vehicle), a walking state (the user moves on foot), or other states (for example, movement by streetcar)) based on the result of sensing performed by the sensor 27. The parking determination unit 213 can determine parking more accurately by determining at least one of the start of parking or the end of parking of the vehicle 30 using the determination result.

The determination as to whether the user of the mobile terminal 20 is in the stationary state, the in-vehicle state (movement by vehicle), the walking state (the user moves on foot), or other states (for example, movement by streetcar) based on the result of sensing performed by the sensor 27 can be performed using any method. For example, first, when the user is in each of the stationary state, the in-vehicle state, the walking state, and a traveling state, a feature quantity is calculated based on the sensing result of each of the acceleration sensor and the geomagnetic sensor mounted in the mobile terminal, and each state of the user is experimentally associated with the feature quantity in advance by machine learning. The parking determination unit 213 can determine the state of the user of the mobile terminal 20 based on information on the association and the result of sensing performed by the sensor 27.

The parking determination unit 213 can also specify the time when parking of the vehicle 30 is started (parking start date and time) and the time when the parking is ended (parking end date and time). The parking determination unit 213 can specify the parking start date and time and the parking end date and time using various methods. For example, the parking determination unit 213 can specify the parking start date and time and the parking end date and time based on the reading performed by the reading unit 211 (for example, based on the time when the identification information on the parking space is read from the two-dimensional code image). The parking determination unit 213 can specify the parking start date and time and the parking end date and time based on the timing when the start of parking and the end of parking are determined using the result and the like of sensing performed by the sensor 27 as described above. The parking determination unit 213 can also specify the parking start date and time and the parking end date and time based on the type and the reception timing of a vehicle signal received from the vehicle 30. For example, the vehicle signal includes at least one of an accessory signal (ACC signal), an automatic (AT) shift signal, an ignition (IG) signal, or a vehicle speed signal. For example, the parking determination unit 213 can specify the parking start date and time based on the timing when the shift signal indicating parking is received, and can specify the parking end date and time based on the timing when the vehicle speed indicated by the vehicle speed signal is changed to above 0 km/h from 0 km/h.

The illegal parking determination unit 214 determines whether or not the parking found by the user is illegal parking performed without complying with reservation based on the identification information on the parking space and the identification information on the vehicle acquired by the reading unit 211 and the like. For example, the determination is executed based on an operation of the user of the mobile terminal 20 who finds parking of a vehicle in a parking space that does not comply with the reservation details. For the determination, the illegal parking determination unit 214 compares the identification information on the parking space, the identification information on the vehicle acquired by the reading unit 211 and the like, and also the current time with reservation information on the parking space. When there is inconsistency in information, the illegal parking determination unit 214 determines that the parking is illegal parking. The reservation information on the parking space is acquired from a database 110 of the server device 10 through the network N.

The transmission unit 215 transmits information on the processing result of the mobile terminal 20 and information stored in the mobile terminal 20 to the outside. For example, the transmission unit 215 can transmit parking reservation information to the server device 10 based on a user input. The parking reservation information is information on a reservation request for parking in the parking lot (parking space). The transmission unit 215 can transmit user information and the identification information on the parking space at a timing corresponding to a user operation (for example, pressing a parking start button or a parking end button), and transmit the parking start date and time or the parking end date and time at a timing specified by the parking determination unit 213.

The transmission unit 215 can transmit information including the user information on the mobile terminal 20 stored in the database 210, the identification information on the parking space read by the reading unit 211 (that is, the identification information on the parking space read from the code image acquired by the camera 26), and the parking start date and time or the parking end date and time specified by the parking determination unit 213 to the server device 10 as parking information.

When the illegal parking determination unit 214 determines illegal parking by the determination, the transmission unit 215 can transmit the information on illegal parking including the identification information on the parking space and an identification number of the vehicle acquired by the reading unit 211 and the user information on the mobile terminal 20 stored in the database 210 to the server device 10 based on an operation of the user.

The transmission unit 215 can transmit the information on illegal parking including images of the identification information on the parking space and the identification information on the vehicle captured by the camera 26 (for example, the image of the two-dimensional code disposed in the parking space and the image of the license plate attached to the vehicle) instead of the identification information on the parking space and the identification number of the vehicle acquired by the reading unit 211 to the server device 10.

As will be described below, when the receiver 216 acquires the identification information on the parking space, the transmission unit 215 can transmit the information on illegal parking including the identification information on the parking space acquired by the receiver 216 instead of the identification information on the parking space acquired by the reading unit 211 to the server device 10.

The receiver 216 receives various types of information from the server device 10. For example, the receiver 216 can receive various types of information such as information on a reservable parking space, a time period in which the user of the mobile terminal 20 parks the vehicle 30 in the parking lot 40, information on a parking fee, and a notification related to parking from the server device 10.

For example, when the transmission unit 215 transmits the information on illegal parking to the server device 10, the receiver 216 receives information on an alternative parkable (reservable) parking space from the server device 10. The user can make a reservation for using the parking space through the operation unit 24 based on information on the alternative parking space. Accordingly, according to the present embodiment, when a vehicle of another person is illegally parked in a parking space reserved for the user, the user can smoothly use an alternative parking space by providing a notification of the illegal parking.

When a device that emits a signal including the identification information on each parking space is installed in each parking space of the parking lot, the receiver 216 can acquire the identification information on the parking space included in the signal received from the device through the communication unit 22. For example, a beacon terminal is installed in each parking space of the parking lot. The receiver 216 can receive a beacon signal emitted from the beacon terminal and acquire the identification information on the parking space included in the beacon signal.

The beacon terminal is a device that continuously transmits a broadcast communication signal (beacon signal). The range reached by the beacon signal is referred to as a beacon region. The area of the beacon region is typically a radius of approximately a few m to a few tens of m.

In each parking space, any other emitting devices such as a radio frequency (RF) tag that emits an electric wave (signal) including the identification information on the parking space, and an emitter that emits an infrared signal including the identification information may be installed instead of the beacon terminal.

The notification unit 217 provides various notifications to the user of the mobile terminal 20. For example, the notification unit 217 can provide a notification to the user when the identification information associated with the parking space is not read by the reading unit 211 even after elapse of a predetermined time period (for example, 10 minutes) from the time when the parking determination unit 213 determines that parking of the vehicle 30 is started. The notification unit 217 can present (notify) a notification received from the server device 10 to the user.

Notifications of the notification unit 217 may be provided using any method. For example, notification details may be displayed on the display unit 25. A notification may be provided using a speaker (not illustrated) included in the mobile terminal 20. A notification may be provided by vibrating the mobile terminal 20. A notification may be provided by combining all or a part of the notification methods.

According to the present embodiment thus far, the mobile terminal 20 can read the identification information on the parking space using the reading unit 211 and transmit information including the user information on the mobile terminal 20 stored in the database 210, the read identification information on the parking space, and the parking start date and time or the parking end date and time to the server device 10 as the parking information using the transmission unit 215. Consequently, information needed for managing parking of parked vehicles can be transmitted to the server device 10 without installing a device such as a camera for recognizing the parked vehicles in the parking lot 40. That is, according to the present embodiment, parking of vehicles can be managed at a low cost.

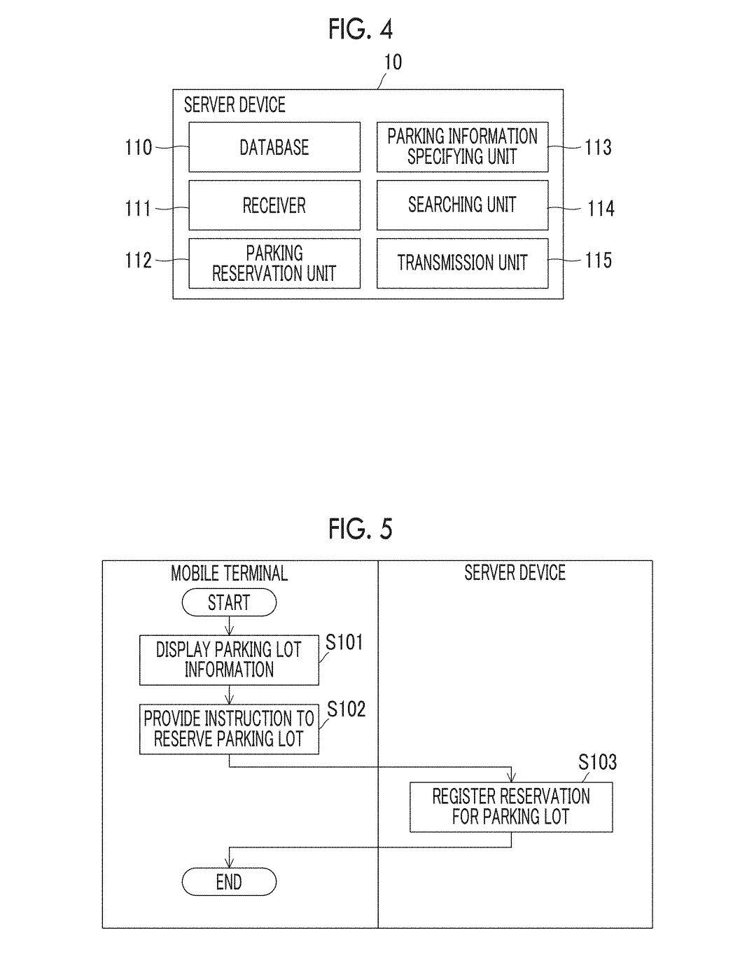

A functional configuration of the server device 10 will be described with reference to FIG. 4. While FIG. 1 illustrates a hardware configuration of the server device 10, FIG. 4 illustrates a functional configuration of the server device 10. As illustrated in FIG. 4, the server device 10 includes, as a main functional configuration, the database 110, a receiver 111, a parking reservation unit 112, a parking information specifying unit 113, a searching unit 114, and a transmission unit 115. For example, the server device 10 implements each functional configuration illustrated in FIG. 4 by causing the CPU 11a to execute a predetermined program stored in the memory 11b and the like in cooperation with the hardware of the server device 10. Hereinafter, each functional configuration will be specifically described.

The database 110 stores various types of information such as information needed for processes executed in the server device 10, information generated by the processes, and information received from external devices. For example, the database 110 stores information on the registered user, information on the registered parking lot (for example, information on the attribute of each parking space included in the parking lot and information on the position of the parking lot), information on a parking reservation made by the user, information on the parking fee, and information on parking lot usage.

The receiver 111 receives various types of information and instructions to execute various processes from devices outside the server device 10. For example, the receiver 111 receives the parking reservation information and the parking information (for example, including at least a part of parking position information, parking start information (parking start instruction), and parking end information (parking end instruction)) and the information on illegal parking transmitted from the transmission unit 215 of the mobile terminal 20. The parking start information (parking start instruction) includes the parking start date and time specified by the parking determination unit 213. The parking end information (parking end instruction) includes the parking end date and time specified by the parking determination unit 213. The information on illegal parking is information on illegal parking that does not comply with the reservation details. Particularly, in the present embodiment, the information on illegal parking is information on illegal parking in a parking space that is reserved for use.

The parking reservation unit 112 performs a process of registering the parking reservation information received through the receiver 111 in the database 110, and a process of updating or deleting the registered parking reservation information. For example, the parking reservation information that is registered and updated in the database 110 includes user (reservation holder) information, parking lot (parking space) information for which a parking reservation is made, reserved start date and time (date and time when reserved parking is started), reserved end date and time (date and time when reserved parking is ended), a parking fee, a parking state (for example, a non-parking state, an in-parking state, or a parking end state), the parking start date and time (date and time when parking is actually started), and the parking end date and time (date and time when parking is actually ended).

The parking information specifying unit 113 specifies information on parking of the vehicle 30 and other vehicles in the parking lot (parking space) as the parking information based on information received by the receiver 111. For example, the parking information specifying unit 113 can specify the user of the mobile terminal 20, the parking position of the parked vehicle 30 (the parking space where the vehicle 30 is parked), and at least one of the parking start date and time or the parking end date and time based on the parking information that is transmitted from the mobile terminal 20 and received by the receiver 111. The specified parking information on the vehicle is stored in the database 110 in association with information on the user of the vehicle.

The parking information specifying unit 113 determines whether or not the specified parking information complies with details indicated by the parking reservation information registered in the database 110. For example, the parking information specifying unit 113 can determine (specify) whether or not the user information, the parking position (parking space), and the parking start date and time indicated by the specified parking information comply with the details indicated by the parking reservation information registered in the database 110.

According to the present embodiment thus far, the parking management system 1 can specify a difference between the details of the registered parking lot reservation and the actual parking status.

The parking information specifying unit 113 can specify the parking time period of the vehicle 30 based on the parking start information and the parking end information that are transmitted from the mobile terminal 20 and received by the receiver 111. The parking information specifying unit 113 can also calculate the parking fee for the vehicle 30 based on the parking time period of the vehicle 30 and parking rate information. For example, the parking rate information is acquired from the database 110.

The searching unit 114 references information on the parking reservation stored in the database 110 and searches for information on an empty parking space (reservable parking space) in the parking lot based on information received from the mobile terminal 20 through the receiver 111. For example, the searching unit 114 can search for a parking space based on a search request for an empty parking space and a search condition that are received from the mobile terminal 20 by a user operation.

The searching unit 114 can search for an alternative parkable parking space (second parking space) based on the information on illegal parking received from the mobile terminal 20 of the user having a reservation for using the parking space (first parking space). Specifically, the information on illegal parking includes the identification information on the first parking space where a vehicle is illegally parked without complying with the reservation, the identification number of the vehicle illegally parked in the parking space, and the user information on the mobile terminal 20 having a reservation in a time slot in which the vehicle is illegally parked in the first parking space where the vehicle is illegally parked. For example, the searching unit 114 can search for a parkable parking space (second parking space) as an alternative for the first parking space from parkable (reservable) parking spaces based on at least one of the distance from the first parking space (for example, the distance from the first parking space is the shortest or less than a predetermined value), the destination of the user who has a reservation for the first parking space, or the attribute of each parking space.

The information on the destination of the user having a reservation for the first parking space may be received from the mobile terminal 20 by a user operation at the time of search or may be stored in advance in the database 110. For example, the searching unit 114 can use the information on the destination that is input when the user operates navigation software installed in advance on the mobile terminal 20 or a vehicle-mounted device of the vehicle 30. The attribute of each parking space includes an attribute such as the area and whether or not there is a roof. The information on the attribute of each parking space is stored in the database 110 in association with the information on each parking space.

The parking space that satisfies the search performed by the searching unit 114 can be reserved for use by the parking reservation unit 112 (for example, as an alternative parking space for the vehicle of the user having a reservation for the parking space which has been illegally used by another person).

The transmission unit 115 transmits information on the processing result of the server device 10 and information stored in the server device 10 to the outside. For example, the transmission unit 115 can transmit the parking information and information on the calculated parking fee of the vehicle 30 specified by the parking information specifying unit 113 to the mobile terminal 20. The transmission unit 115 can transmit information on the parking space satisfying the search performed by the searching unit 114 to a device that is used when a reservation for using the parking space is made (for example, the mobile terminal 20 of the user who has a reservation for use), or a device registered in advance. The transmission unit 115 transmits various notifications (messages) to external devices. For example, when the parking information specifying unit 113 determines that the parking information specified by the parking information specifying unit 113 does not comply with the details indicated by the parking reservation information registered in the database 110, the transmission unit 115 notifies the corresponding mobile terminal 20 that the parking is non-reserved parking (transmits a non-reserved parking notification). Notification examples transmitted to the mobile terminal 20 of the reservation holder by the transmission unit 115 will be listed below.

Notification Examples [0068]

(1) Notification 1 When Use of Parking Lot is Not Reserved

Notification condition: The parking start information that does not comply with the reservation details (or for which a reservation is not made) is received from the mobile terminal 20, and the parking space indicated by the details of the parking start instruction is currently not in a rentable time period or is currently reserved for another user. Notification details: “You have stopped in a parking lot where you do not have a reservation. This parking lot cannot be currently used. Please move your vehicle. Location: [parking lot name]”

(2) Notification 2 When Use of Parking Lot is Not Reserved

Notification condition: The parking start information that does not comply with the reservation details (or for which a reservation is not made) is received from the mobile terminal 20, and the parking space indicated by the details of the parking start instruction is currently in the rentable time period and is currently not reserved for another user.

Notification details: “You have stopped in a parking lot where you do not have a reservation. Please move your vehicle, or make a reservation for the parking lot. Location: [parking lot name]”

(3) Notification of Start of Parking

Notification condition: The parking start information that complies with the reservation details is received from the mobile terminal 20.

Notification details: “Parking has started. Location: [parking lot name] Reserved start: XX:XX Reserved end: XX:XX Reserved parking fee: XXX yen”

(3a) Notification of Start of Parking before Reserved Time Period

Notification condition: The parking start instruction is received in the reserved time period by the receiver 111, but the parking start date and time are before the reserved time period.

Notification details: “Parking has started. An additional fee will be charged for parking before the reserved start. Location: [parking lot name] Reserved start: XX:XX Reserved end: XX:XX Reserved parking fee: XXX yen Parking start: XX:XX Additional fee: XXX yen”

(3b) Notification for Prompting Operation of Pressing Parking Start Button

Notification condition: The parking start date and time (specified by the parking determination unit 213) are received by the receiver 111, but the parking start instruction to be provided by a user operation in the mobile terminal 20 is not received even after elapse of a predetermined time period.

Notification details: “You have entered a parking lot where you have a reservation. Please press the parking start button.”

(3c) Notification for Prompting Operation of Pressing Parking End Button

Notification condition: The parking end date and time (specified by the parking determination unit 213) are received by the receiver 111, but the parking end instruction to be provided by a user operation in the mobile terminal 20 is not received even after elapse of a predetermined time period.

Notification details: “You have exited from the parking lot where you have a reservation. Please press the parking end button.”

(4) Notification of Start Parking before Reserved Time Period at Available time

Notification condition: The parking start instruction is received by the receiver 111 before the reserved time period. The parking start date and time are in the rentable time period. No reservation has currently been made for another user.

Notification details: “The start of parking is before the reserved time period. The parking lot can be currently used. Please update your reservation. Location: [parking lot name] Reserved start: XX:XX Reserved end: XX:XX Reserved parking fee: XXX yen”

(5) Notification of Start Parking before Reserved Time Period at Unavailable Time

Notification condition: The parking start instruction is received by the receiver 111 before the reserved time period. The parking start date and time are not in the rentable time period, or a reservation has currently been made for another user.

Notification details: “The start of parking is before the reserved time period. The parking lot cannot be currently used. Please move your vehicle. Location: [parking lot name] Reserved start: XX:XX Reserved end: XX:XX Reserved parking fee: XXX yen”

(6) Notification 1 of Arrival of End of Parking Time Period Notification condition: A determination that a certain time period is left before the end of the reserved time period is made during parking. The parking start date and time are in the rentable time period. No reservation has currently been made for another user.

Notification details: “The reserved time period will be ended soon. Please update your reservation when the parking will exceed the end of the time period. A fee of XXX yen will be charged every 00 minutes. Location: [parking lot name] Reserved start: XX:XX Reserved end: XX:XX Reserved parking fee: XXX yen”

(7) Notification 2 of Arrival of End of Parking Time Period

Notification condition: A determination that a certain time period is left before the end of the reserved time period is made during parking. The parking lot will not be in the rentable time period after the end of the reservation, or a reservation has currently been made for another user.

Notification details: “The reserved time period will be ended soon. Please use the parking lot within the time period. Location: [parking lot name] Reserved start: XX:XX Reserved end: XX:XX Reserved parking fee: XXX yen”

(8) Notification of Excess of Parking Time Period

Notification condition: A determination is made that parking continues even after the reserved time period. The parking lot is currently in the rentable time period. No reservation has currently been made for another user.

Notification details: “The reserved time period has exceeded. An additional fee of XXX yen will be charged every OO minutes. Location: [parking lot name] Reserved start: XX:XX Reserved end: XX:XX Reserved parking fee: XXX yen”

(9) Notification of Excess of Parking Time Period for Prompting Movement

Notification condition: A determination is made that parking continues even after the reserved time period. The parking lot is currently not in the rentable time period, or a reservation has been made for another user.

Notification details: “The reserved time period has exceeded. The parking lot cannot be currently used. Please move your vehicle as soon as possible. Location: [parking lot name] Reserved start: XX:XX Reserved end: XX:XX Reserved parking fee: XXX yen”

(10) Notification to User of Illegal Parking When Valid User Parks in Alternative

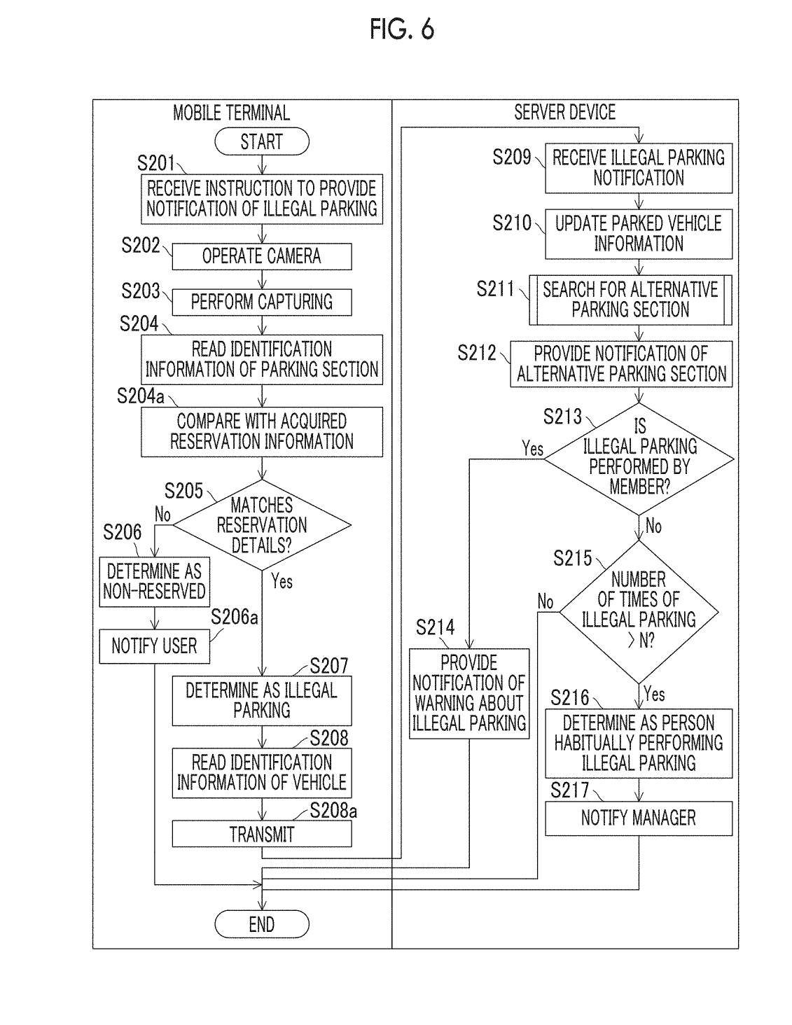

Parking Lot Due to Excess of Parking Time Period (corresponds to S214 in FIG. 6 described below)

Notification condition: A member of a parking management service has performed illegal parking (corresponds to Yes in S213 in FIG. 6).

Notification details: “Warning: Due to your parking performed in a non-reserved time period, a valid user having a reservation was unable to park. Please refrain from illegal parking from now on.”

(11) Notification of End of Parking (Ended in Reserved Time Period)

Notification condition: The parking end instruction is received in the reserved time period.

Notification details: “Parking has ended. There is no additional fee. Location: [parking lot name] Reserved start: XX:XX Reserved end: XX:XX Reserved parking fee: XXX yen Parking start: xx:xx Parking end: xx:xx Payable fee: xxx yen”

(12) Notification of End of Parking (Exceeding Reserved Time Period)

Notification condition: The parking end instruction is received after the reserved time period.

Notification details: “Parking has ended. An additional fee of XXX yen will be charged. Location: [parking lot name] Reserved start: XX:XX Reserved end: XX:XX

Reserved parking fee: XXX yen Parking start: xx:xx Parking end: xx:xx Payable fee: xxx yen”

(13) Notification of Parking Lot Different from When Parking Is Started Notification condition: The parking end instruction is received in a parking lot where a reservation is not made.

Notification details: “The parking lot is different from where you have parked. Please check again. Location: [parking lot name]”

It is considered that the reservation holder wants to continue parking after the reserved time period and moves to another empty parking lot immediately before the end of the reserved time period. In such a case, the notification in (13) is effective.

### 3. EXAMPLES

A process flow of each specific example of the parking management system 1 will be described below. The processes described above will not be described or will be briefly described here.

### 3.1 Example 1

Example 1 is an example in which a process of searching for a parking space within a predetermined distance from the reserved parking space is performed in order to make a reservation for an alternative parking space when illegal parking is found in the reserved parking space.

### Example 1.1

In the present example, an example of processes in which the user of the mobile terminal 20 makes a reservation for using a parking space and finds illegal parking performed by another person when trying to use the reserved parking space, and an alternative parking space is reserved will be described with reference to flowcharts of FIG. 5 to FIG. 10. In the flowcharts of FIG. 5 to FIG. 10, each process step in a region illustrated by “MOBILE TERMINAL” represents a process step performed by the mobile terminal 20. Each process step in a region illustrated by “SERVER DEVICE” represents a process step performed by the server device 10. The same applies to other flowcharts.

An example of a process in which the user of the mobile terminal 20 owning the vehicle 30 makes a reservation for using a parking space will be described with reference to FIG. 5.

First, the mobile terminal 20 displays information on a usable (parkable) parking space (including a list or a map of parking spaces) on the display unit 25 by an operation instruction from the user (step S101). For example, the information on the usable parking space is acquired from the database 110 of the server device 10 through the network N. Then, the mobile terminal 20 receives an instruction to reserve the parking space to be used by the user by an operation of the user and transmits the instruction for the reservation and the identification information on the user to the server device 10 (step S102).

The server device 10 registers the reservation for using the parking space in the database 110 in accordance with the received instruction for the reservation (step S103). For example, registration details of the reservation for using the parking space include information on an identification number of the user having the reservation, an identification number of the parking space, the reserved date and time of the start of use, and the reserved date and time of the end of use depending on the details of the received instruction. Then, the process illustrated in FIG. 5 is ended.

An example of a process in which the user of the mobile terminal 20 finds illegal parking performed by another person when trying to use the reserved parking space, and an alternative parking space is reserved will be described with reference to FIG. 6. Such a process is started when the user of the mobile terminal 20 drives the vehicle 30 to move to the vicinity of the parking space in order to use the reserved parking space and finds a vehicle that is illegally parked in the parking space without complying with the reservation.

First, the mobile terminal 20 receives an instruction to provide a notification of illegal parking by an operation of the user (for example, tapping or pressing an illegal parking notification button) (step S201) and operates the camera 26 (step S202). The mobile terminal 20 captures an image of the two-dimensional code disposed in the parking space where the illegally parked vehicle is parked (that is, the parking space reserved for the user of the mobile terminal 20), and the license plate on which the identification information on the illegally parked vehicle is displayed, in accordance with an instruction from the user (step S203). The mobile terminal 20 reads the identification information on the parking space (parking position information) from the image of the two-dimensional code captured in step S203 (step S204).

Then, the mobile terminal 20 acquires the reservation information at the current time for the parking space corresponding to the identification information acquired in step S204 from the database 110 of the server device 10 through the network N, and compares the reservation information with the identification information acquired in step S204 and the identification information on the user of the mobile terminal 20 (step S204a). The mobile terminal 20 determines whether or not the parking space corresponding to the identification information acquired in step S204 is reserved for the user of the mobile terminal 20 at the current time based on the comparison result in step S204a (step S205). The processes of comparison and determination in steps S204a, S205 may be performed in the server device 10, and information on the determination result may be transmitted to the mobile terminal 20 from the server device 10.

When the mobile terminal 20 in step S205 determines that the parking space corresponding to the identification information acquired in step S204 is reserved for the user of the mobile terminal 20 at the current time (Yes in step S205), the process proceeds to step S207. Otherwise (No in step S205), the process proceeds to step S206.

In step S206, the mobile terminal 20 determines that the user who provides an instruction to provide a notification of illegal parking in step S201 does not have a reservation for using the parking space. In step S206a, the mobile terminal 20 notifies the user that the user does not have a reservation for using the parking space by, for example, displaying the notification on the display unit 25. Then, the process illustrated in FIG. 6 is ended.

In step S207, the mobile terminal 20 determines that illegal parking is performed in the parking space reserved for the user, and reads the identification information on the illegally parked vehicle from the image of the license plate captured in step S203 (step S208). Then, the mobile terminal 20 transmits an illegal parking notification including the identification information on the user of the mobile terminal 20, the identification information on the parking space where illegal parking is performed, the identification information on the illegally parked vehicle, information on the date and time when the image is captured in step S203, and the image of the license number of the illegally parked vehicle to the server device 10 (step S208a).

The server device 10 receives the illegal parking notification (information on the illegal parking in the parking space where a reservation for use is made) from the mobile terminal 20 (step S209) and registers the information on illegal parking in the database 110 based on the information included in the received notification (step S210).

Then, the server device 10 searches for an alternative parking space for the user to park the vehicle 30, registers a reservation for the parking space specified by the search (step S211), and notifies the mobile terminal 20 (or a device registered in advance) of information on the alternative parking space for which a reservation is registered (step S212). The process of searching for the alternative parking space and registering a reservation for the alternative parking space in step S211 will be specifically described below.

Then, the server device 10 determines whether or not the illegal parking is illegal parking performed by a user who is registered in the database 110 as a member of the parking management service of the parking management system 1, based on the identification information on the illegally parked vehicle included in the illegal parking notification received in step S209 (step S213). When the server device 10 determines that the illegal parking is performed by a member (Yes in step S213), the process proceeds to step S214. Otherwise (No in step S213), the process proceeds to step S215.

In step S214, the server device 10 transmits a notification of warning about the illegal parking to the mobile terminal 20 of the user who is specified as a member in step S213. Then, the process illustrated in FIG. 6 is ended.

In step S215, the server device 10 specifies the number of times of illegal parking for the currently illegally parked vehicle based on the information on illegal parking registered in the database 110, and determines whether or not the number of times of illegal parking exceeds a predetermined value N (for example, five). When the server device 10 determines that the number of times of illegal parking does not exceed the predetermined value N (No in step S215), the process in FIG. 6 is ended. Otherwise (Yes in step S215), the process proceeds to step S216.

In step S216, the server device 10 determines that the currently illegally parked vehicle is owned by a person who habitually performs illegal parking, and notifies a manager of the parking lot that illegal parking is performed by a person habitually performing illegal parking (step S217). Then, the process illustrated in FIG. 6 is ended.

According to the present embodiment thus far, the use of parking spaces is managed in compliance with the reservation details of the parking spaces managed by the parking management system 1. When a parking space is used without complying with the reservation details, and the user having a reservation cannot use the parking space in compliance with the reservation details, the user can provide a notification of the illegal parking. Accordingly, a reservation for an alternative parking space that can be used instead is registered, and the user can use the alternative parking space. Consequently, even when a parking space is illegally used, the user having a reservation for the parking space can use an alternative parking space.

### Example 1.2

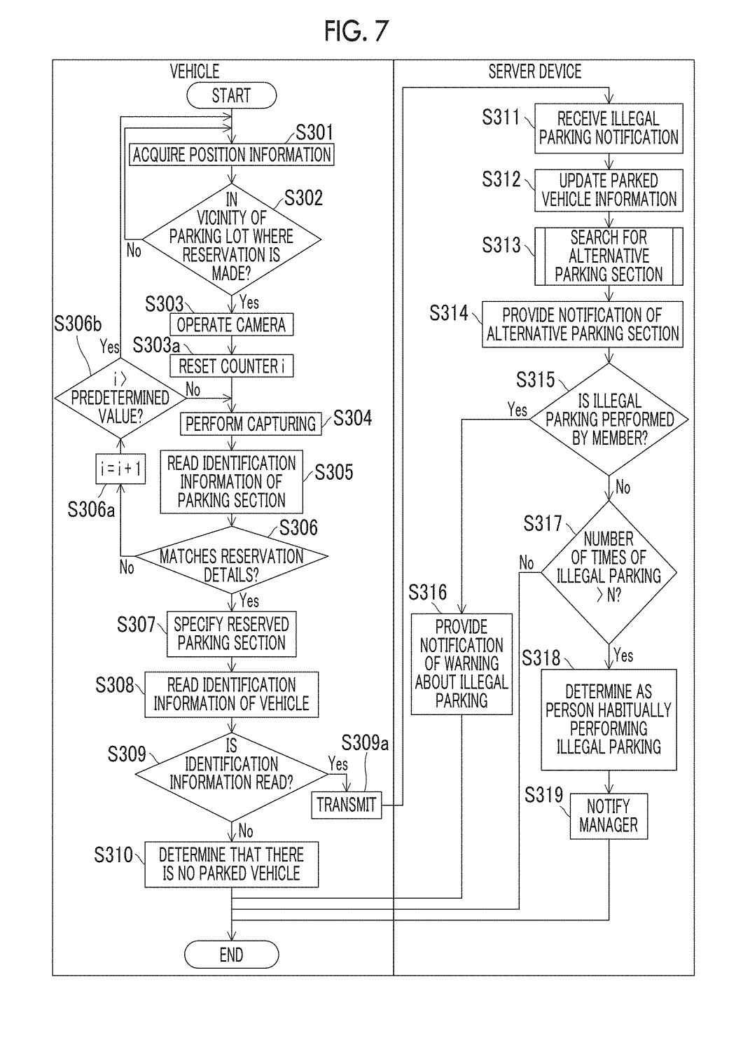

Example 1.2 will be described with reference to FIG. 7. In Example 1.1 described with reference to FIG. 6, an instruction to provide a notification of illegal parking is provided based on information read from the image captured through the camera 26 of the mobile terminal 20. Meanwhile, in Example 1.2, an instruction to provide a notification of illegal parking is provided based on information read from the image captured through a camera mounted in the vehicle 30.

A process in FIG. 7 is started when the user of the mobile terminal 20 drives the vehicle 30 to move to the vicinity of the parking space in order to use the reserved parking space and finds a vehicle that is illegally parked in the parking space without complying with the reservation.

First, the vehicle 30 acquires its current position information using its positioning function (step S301) and determines whether or not the current position of the vehicle 30 is in the vicinity (for example, within 10 m) of the parking lot where the user of the mobile terminal 20 has a reservation (step S302). Information on the parking lot where the user has a reservation is acquired from the database 110 of the server device 10 through the network N.

When the vehicle 30 determines that the vehicle 30 is in the vicinity of the parking lot where the user has a reservation (Yes in step S302), the vehicle 30 operates the camera (step S303). Then, the value of a counter i stored in the storage unit 13 included in the vehicle 30 is reset (for example, the counter i is set to zero) (step S303a). The vehicle 30 captures an image of the surrounding area (step S304) and reads the identification information on the parking space (parking position information) from the image of the two-dimensional code which is disposed in the parking space in the parking lot and included in the captured image (step S305).

Then, the vehicle 30 determines whether or not the parking space corresponding to the identification information acquired in step S305 is reserved for the user of the vehicle 30 (mobile terminal 20) at the current time (step S306). Specifically, the vehicle 30 acquires the reservation information at the current time for the parking space corresponding to the identification information acquired in step S305 from the database 110 of the server device 10 through the network N, and performs the determination by comparing the reservation information with the identification information acquired in step S305 and the identification information on the user of the vehicle 30 (mobile terminal 20). The process of determination may be performed in the server device 10, and information on the determination result may be transmitted to the vehicle 30 from the server device 10.

When the vehicle 30 in step S306 determines that the parking space corresponding to the identification information acquired in step S305 is reserved for the user of the vehicle 30 at the current time (Yes in step S306), the process proceeds to step S307. Otherwise (No in step S306), the process proceeds to step S306a.

In step S306a, the counter i is incremented by one. Then, the vehicle 30 determines whether or not the value of the counter i is greater than a predetermined value (for example, five) (step S306b). When the vehicle 30 determines that the value of the counter i is greater than the predetermined value (Yes in step S306b), the process proceeds to step S301. Otherwise (No in step S306b), the process proceeds to step S304.

In step S307, the vehicle 30 specifies the parking space corresponding to the identification information specified in step S305 as a reserved parking space. Then, the vehicle 30 tries to specify an image of a license plate of a vehicle parked in the parking space specified as a reserved parking space in step S307 from the image included in the image captured in step S304, and read the identification information on the vehicle from the image of the license plate (step S308).

When the identification information on the vehicle is read in step S308 (Yes in step S309), the vehicle 30 determines that illegal parking is performed in the reserved parking space, and transmits the illegal parking notification including the identification information on the user of the vehicle 30 (mobile terminal 20), the identification information on the parking space where the illegal parking is performed, the identification information on the illegally parked vehicle, information on the date and time when the image is captured in step S304, and the image of the license number of the illegally parked vehicle to the server device 10 (step S309a).

When the identification information on the vehicle is not read in step S308 (No in step S309), the vehicle 30 determines that there is no vehicle parked in the reserved parking space specified in step S305 (step S310), and the process illustrated in FIG. 7 is ended.

In step S311, the server device 10 receives the illegal parking notification from the vehicle 30. Then, the server device 10 registers the information on illegal parking in the database 110 based on the information included in the received notification (step S312).

Then, the server device 10 searches for an alternative parking space for the user to park the vehicle 30, registers a reservation for the parking space specified by the search (step S313), and notifies the vehicle 30 (or a device registered in advance) of information on the alternative parking space for which a reservation is registered (step S314). The process of searching for the alternative parking space and registering a reservation for the alternative parking space in step S314 will be specifically described below.

Then, the server device 10 determines whether or not the illegal parking is illegal parking performed by a user who is registered in the database 110 as a member of the parking management service of the parking management system 1, based on the identification information on the illegally parked vehicle included in the illegal parking notification received in step S311 (step S315). When the server device 10 determines that the illegal parking is performed by a member (Yes in step S315), the process proceeds to step S316. Otherwise (No in step S315), the process proceeds to step S317.

In step S316, the server device 10 transmits a notification of warning about the illegal parking to the vehicle 30 of the user who is specified as a member in step S315. Then, the process illustrated in FIG. 7 is ended.

In step S317, the server device 10 specifies the number of times of illegal parking for the currently illegally parked vehicle based on the information on illegal parking registered in the database 110, and determines whether or not the number of times of illegal parking exceeds the predetermined value N (for example, five). When the server device 10 determines that the number of times of illegal parking does not exceed the predetermined value N (No in step S317), the process in FIG. 7 is ended. Otherwise (Yes in step S317), the process proceeds to step S318.

In step S318, the server device 10 determines that the currently illegally parked vehicle is owned by a person who habitually performs illegal parking, and notifies the manager of the parking lot that illegal parking is performed by a person habitually performing illegal parking (step S319). Then, the process illustrated in FIG. 7 is ended.

### Example 1.3

In Example 1.3, it is assumed that the parking management system 1 specifies the start of parking and the end of parking of a vehicle based on the result of reading and the like of the image of the two-dimensional code disposed in a parking space by the mobile terminal 20 or the vehicle 30 at the start of parking and the end of parking. The specified date and time of the start of parking and the end of parking of each vehicle in each parking space are stored and managed in the database 110.

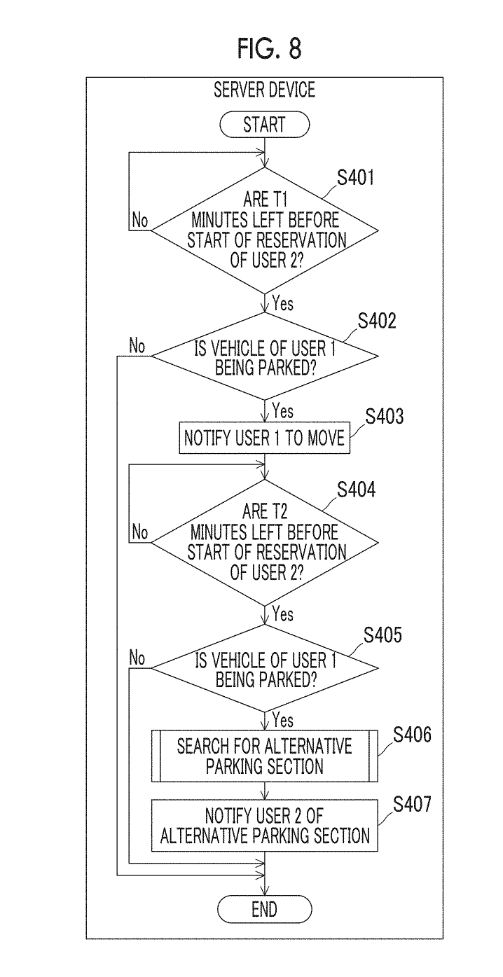

Based on such an assumption, a process of specifying illegal parking and reserving an alternative parking space in Example 1.3 will be described with reference to FIG. 8. In the process illustrated in FIG. 8, it is assumed that a user 1 (of the vehicle 30) has a reservation for using the parking space 41 in FIG. 3 in a certain time slot, and that a user 2 (of the vehicle 30) has a reservation for using the parking space 41 in the subsequent time slot.

First, the server device 10 references the database 110 and determines whether or not T1 minutes (for example, 30 minutes) or less are left before the date and time of the reserved start of parking of the vehicle 30 of the user 2 using the parking space 41 (step S401). When the server device 10 determines that T1 minutes or less are left (Yes in step S401), the server device 10 references the database 110 and determines whether or not the use (parking) of the parking space 41 by the user 1 is ended (step S402). When the server device 10 determines that the user 1 is still using the parking space 41 (Yes in step S402), the process proceeds to step S403. Otherwise (No in step S402), the process illustrated in FIG. 8 is ended.

In step S403, the server device 10 notifies the mobile terminal 20 of the user 1 that the vehicle 30 parked in the parking space 41 should be moved.

Then, in step S404, the server device 10 references the database 110 and determines whether or not T2 minutes (for example, 10 minutes) or less are left before the date and time of the reserved start of parking of the vehicle 30 of the user 2 in the parking space 41 (step S404). T2 minutes are shorter than T1 minutes. When the server device 10 determines that T2 minutes or less are left (Yes in step S404), the server device 10 references the database 110 and determines whether or not the use (parking) of the parking space 41 by the user 1 is ended (step S405). When the server device 10 determines that the user 1 is still using the parking space 41 (Yes in step S405), the process proceeds to step S406. Otherwise (No in step S405), the process illustrated in FIG. 8 is ended.

In step S406, the server device 10 searches for an alternative parking space for the user 2 to park the vehicle 30, and registers a reservation for the parking space specified by the search. In step S407, the server device 10 notifies the mobile terminal 20 of the user 2 of information on the alternative parking space for which a reservation is registered, and the process illustrated in FIG. 8 is ended. The process of searching for the alternative parking space and registering a reservation for the alternative parking space in step S406 will be specifically described below.

### Example 1.4

In Example 1.4, it is assumed that a device (for example, a beacon terminal) that emits a signal including the identification information on each parking space is installed in each parking space of the parking lot, and that the mobile terminal 20 or the vehicle 30 can acquire the identification information on the parking space included in the signal (for example, a beacon signal) received from the device through the communication unit 22.

In Example 1.4, the mobile terminal 20 can acquire information (sensor information) sensed by the sensor 27 and determine the state of movement of the user (for example, whether or not parking is ended, or whether or not parking is started) based on the sensor information (that is, can determine the date and time of the start of parking and the date and time of the end of parking). For example, first, when the user is in each of the stationary state, the in-vehicle state, the walking state, and the traveling state, a feature quantity is calculated based on the sensing result of each of the acceleration sensor and the geomagnetic sensor mounted in the mobile terminal, and each state of the user is associated with the feature quantity by machine learning. The mobile terminal 20 can determine whether or not the user of the mobile terminal 20 starts parking, or whether or not the user of the mobile terminal 20 ends parking based on the associated information and the result of sensing performed by the sensor 27.

In Example 1.4, the vehicle 30 can specify the date and time of the start of parking and the date and time of the end of parking of the vehicle 30 based on the type and the reception timing of the vehicle signal. For example, the vehicle signal includes at least one of the accessory signal (ACC signal), the automatic (AT) shift signal, the ignition (IG) signal, or the vehicle speed signal.

The specified date and time of the start of parking and the end of parking of each vehicle in each parking space are stored and managed in the database 110.

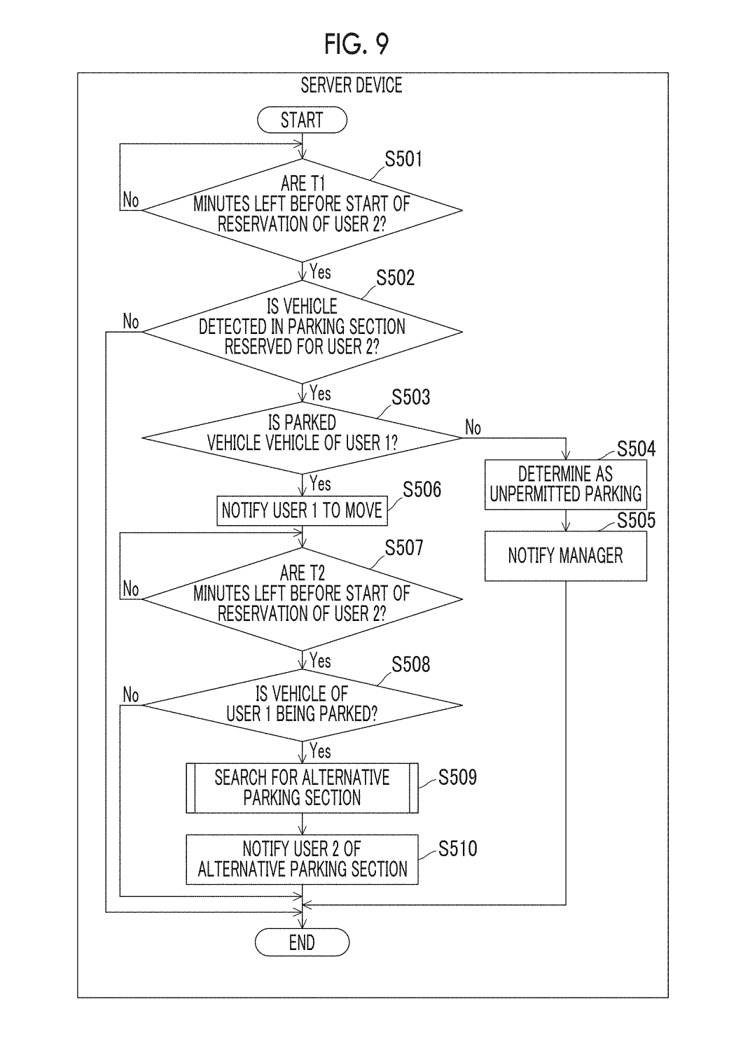

Based on such an assumption, a process of specifying illegal parking and reserving an alternative parking space in Example 1.4 will be described with reference to FIG. 9. In the process illustrated in FIG. 9, it is assumed that the user 1 (of the vehicle 30) has a reservation for using the parking space 41 in FIG. 3 in a certain time slot, and that the user 2 (of the vehicle 30) has a reservation for using the parking space 41 in the subsequent time slot.

First, the server device 10 references the database 110 and determines whether or not T1 minutes (for example, 30 minutes) or less are left before the date and time of the reserved start of parking of the vehicle 30 of the user 2 in the parking space 41 (step S501). When the server device 10 determines that T1 minutes or less are left (Yes in step S501), the server device 10 references the database 110 and determines whether or not the use (parking) of the parking space 41 by the user 1 is ended (step S502). When the server device 10 determines that the user 1 is still using the parking space 41 (Yes in step S502), the process proceeds to step S503. Otherwise (No in step S502), the process illustrated in FIG. 9 is ended.

In step S503, the server device 10 references the database 110 and determines whether or not the vehicle parked in the parking space 41 is the vehicle 30 of the user 1. The server device 10 can determine whether or not the vehicle parked in the parking space 41 is the vehicle 30 of the user 1 by referencing the reservation information on the parking space 41 and the time of the start of parking and the time of the end of parking in the parking space 41 stored in the database 110. When the server device 10 determines that the vehicle is not the vehicle 30 of the user 1 (No in step S503), the process proceeds to step S504. Otherwise (Yes in step S503), the process proceeds to step S506.

In step S504, the server device 10 determines that the vehicle parked in the parking space 41 is a vehicle that does not have a reservation and is parked without permission. Then, the server device 10 notifies the manager of the unpermitted parking in the parking space 41 (step S505), and the process illustrated in FIG. 9 is ended.

In step S506, the server device 10 notifies the mobile terminal 20 of the user 1 that the vehicle 30 parked in the parking space 41 should be moved.

Then, in step S507, the server device 10 references the database 110 and determines whether or not T2 minutes (for example, 10 minutes), shorter than T1 minutes, or less are left before the date and time of the reserved start of parking of the vehicle 30 of the user 2 in the parking space 41 (step S507). When the server device 10 determines that T2 minutes or less are left (Yes in step S507), the server device 10 references the database 110 and determines whether or not the use (parking) of the parking space 41 by the user 1 is ended (step S508). When the server device 10 determines that the user 1 is still using the parking space 41 (Yes in step S508), the process proceeds to step S509. Otherwise (No in step S508), the process illustrated in FIG. 9 is ended.

In step S509, the server device 10 searches for an alternative parking space for the user 2 to park the vehicle 30, and registers a reservation for the parking space specified by the search. In step S510, the server device 10 notifies the mobile terminal 20 of the user 2 of information on the alternative parking space for which a reservation is registered, and the process illustrated in FIG. 9 is ended. The process of searching for the alternative parking space and registering a reservation for the alternative parking space in step S509 will be specifically described below.

Process of Searching for Alternative Parking Space and Registering Reservation for Alternative Parking Space

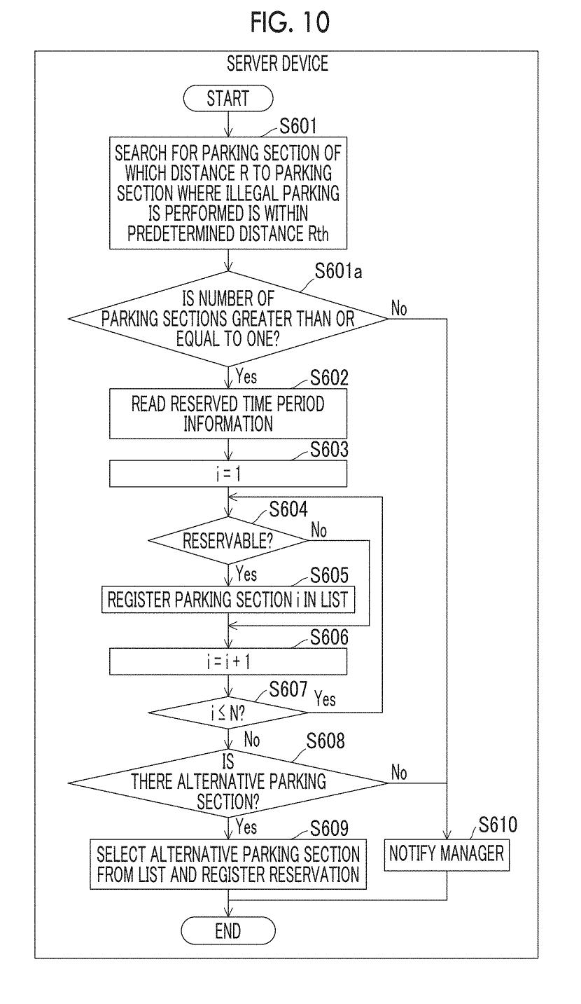

The process of searching for the alternative parking space and registering a reservation for the alternative parking space in S211 in FIG. 6, S313 in FIG. 7, S406 in FIGS. 8, and S509 in FIG. 9 will be described with reference to FIG. 10.

First, the server device 10 references the database 110 and searches for a parking space of which a distance R from the parking space where illegal parking is performed (or the parking space for which the server device 10 in the processes in FIG. 8 and FIG. 9 determines that T2 minutes or less are left before the date and time of the reserved start of parking by the user 2; hereinafter, referred to as “parking space where illegal parking is performed”) is less than a predetermined distance Rth (for example, 300 m) (step S601). The server device 10 determines whether or not the number N of parking spaces specified by the search in step S601 is greater than or equal to one (that is, whether or not there are one or more parking spaces) (step S601a). When the number N of parking spaces is greater than or equal to one, the process proceeds to step S602. Otherwise, the process proceeds to step S610.

In step S602, the server device 10 references the database 110 and reads the reserved time period for the user of the parking space where illegal parking is performed.

Then, the server device 10 sets the variable i to one (step S603) and repeats the processes of step S604 to step S607 N times for each of the N parking spaces specified by the search in step S601.

The server device 10 determines whether or not the i-th parking space specified by the search in step S601 can be used (can be reserved) in the reserved time period read in step S602 (step S604). When the server device 10 determines that the i-th parking space can be used (Yes in step S604), the process proceeds to step S605. Otherwise (No in step S604), the process proceeds to step S606. In step S605, the server device 10 additionally registers information on the parking space determined as a reservable parking space in the list as information on a candidate for the alternative parking space (step S605). In step S606, the server device 10 increments i by one.

Then, when the value of i is less than or equal to N (Yes in step S607), the process proceeds to step S604. Otherwise, the process proceeds to step S608.

In step S608, the server device 10 references the list in which the information on the parking space is registered in step S605, and determines whether or not there is a registered parking space in the list. When the server device 10 determines that there is no registered parking space in the list (No in step S608) (that is, when the server device 10 determines that there is no alternative parking space), the server device 10 notifies the manager that there is no registered parking space, and that the manager should quickly go to the reserved parking space (step S610). Then, the process illustrated in FIG. 10 is ended.

When the server device 10 determines that there is a registered parking space in the list (Yes in step S608) (that is, when the server device 10 determines that there is an alternative parking space), the server device 10 selects any parking space from parking spaces registered in the list and registers a reservation for the selected parking space as an alternative parking space in the database 110 (step S609). Then, the process illustrated in FIG. 10 is ended.

### 3.2 Example 2

Example 2 is an example in which a process of searching for a parking space within a predetermined distance from the destination of the user is performed in order to make a reservation for an alternative parking space when illegal parking is found in the reserved parking space.

The same processes as the processes described with reference to FIG. 5 to FIG. 9 in Example 1 are performed in Example 2. In Example 2, details of the process of searching for the alternative parking space and registering a reservation for the alternative parking space in S211 in FIG. 6, S313 in FIG. 7, S406 in FIGS. 8, and S509 in FIG. 9 are different.

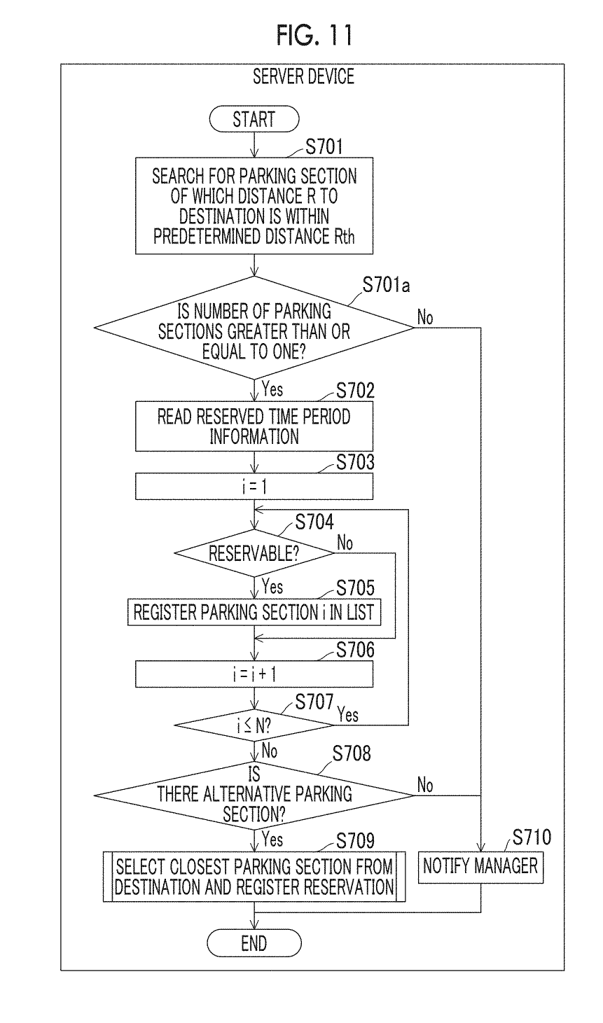

The process of searching for the alternative parking space and registering a reservation for the alternative parking space in S211 in FIG. 6, S313 in FIG. 7, S406 in FIGS. 8, and S509 in FIG. 9 in Example 2 will be specifically described with reference to FIG. 11.

First, the server device 10 references the database 110 and searches for a parking space of which the distance R from the destination of the user is less than the predetermined distance Rth (for example, 300 m) (step S701). The information on the destination of the user may be received from the mobile terminal 20 by a user operation at the time of performing the process or may be stored in advance in the database 110. For example, the information on the destination that is input when the user operates the navigation software installed in advance on the mobile terminal 20 or a vehicle-mounted device of the vehicle 30 is used. The same applies to the processes described below. Then, the process proceeds to step S701a. The processes of steps S701a to S708, S710 are the same as the processes of steps S601a to S608, S610 in FIG. 10 respectively and thus, will not be described here.

In step S709, the server device 10 selects the closest parking space from parking spaces registered in the list and registers a reservation for the selected parking space as an alternative parking space in the database 110. Then, the process illustrated in FIG. 11 is ended.

### 3.3 Example 3

Example 3 is an example in which a process of searching for a parking space based on the distance from the destination of the user and the attribute of each parking space is performed in order to make a reservation for an alternative parking space when illegal parking is found in the reserved parking space.

The same processes as the processes described with reference to FIG. 5 to FIG. 9 in Example 1 are performed in Example 3. In Example 3, details of the process of searching for the alternative parking space and registering a reservation for the alternative parking space in S211 in FIG. 6, S313 in FIG. 7, S406 in FIGS. 8, and S509 in FIG. 9 are different.

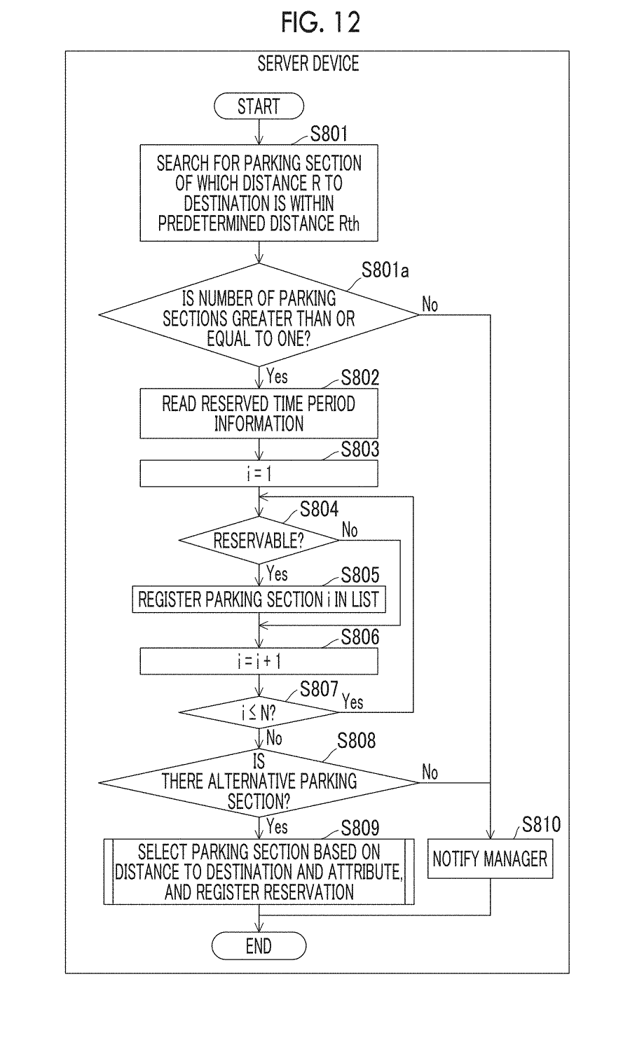

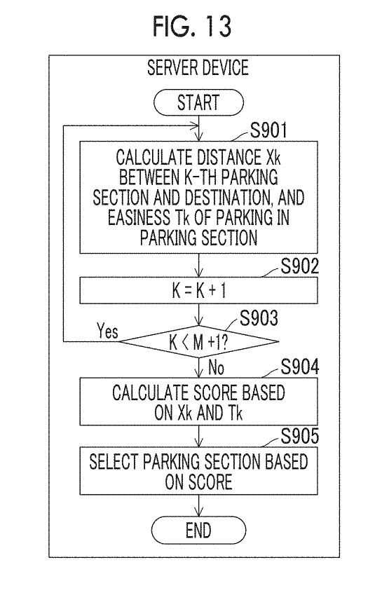

The process of searching for the alternative parking space and registering a reservation for the alternative parking space in S211 in FIG. 6, S313 in FIG. 7, S406 in FIGS. 8, and S509 in FIG. 9 in Example 3 will be specifically described with reference to FIG. 12 and FIG. 13.

The processes of steps S801 to S808, S810 in FIG. 12 are the same as the processes of steps S701 to S708, S710 in FIG. 11 respectively and thus, will not be described here.

In step S809, the server device 10 calculates scores for parking spaces registered in the list in step S805 based on the distance from the destination and the attribute of each parking space. The server device 10 selects a parking space based on the scores and registers a reservation for the selected parking space as an alternative parking space in the database 110. Then, the process illustrated in FIG. 12 is ended.

The attribute of each parking space is a parameter indicating a characteristic of each parking space that is increased as the possibility of the reservation holder wanting to use the parking space is increased. For example, the attribute of each parking space includes an attribute related to the easiness of parking in each parking space. The attribute related to the easiness of parking includes an attribute such as the area of the parking space and whether or not there is a roof. A roof disposed in a parking space further reduces a decrease in the field of view of a driver of a vehicle when it rains or snows, and thus, further improves the easiness of parking. Thus, the attribute of whether or not there is a roof includes the attribute related to the easiness of parking. The attribute related to the easiness of parking is not limited thereto and includes an attribute that makes the reservation holder feel easy to park. For example, some reservation holders feel easy to park in a parking lot where payment can be made by a credit card. Thus, an attribute of whether or not payment can be made by a credit card may be included in the attribute related to the easiness of parking. Some reservation holders determine that it is easier to park in a single level parking lot than in a multilevel parking lot. Thus, an attribute of whether or not the parking lot is a multilevel parking lot may be included in the attribute related to the easiness of parking. Furthermore, even in the single level parking lot, there are reservation holders who determine that it is easier to park in a parking lot where gates are installed at the entrance and the exit of the parking lot, than in a parking lot where a barrier is disposed in each parking space. Thus, an attribute of whether or not gates are installed at the entrance and the exit of the parking lot may be included in the attribute related to the easiness of parking. Besides the attribute related to the easiness of parking, the attribute of each parking space may include an attribute of whether or not the reservation holder has used the parking lot in the past. When the parking lot has been used in the past, the reservation holder can recall how the parking lot was. Thus, the possibility of the reservation holder wanting to use the parking lot is increased. In the process of step S809 in FIG. 12, any attribute that affects the possibility of the reservation wanting to use the parking space can be used as the attribute of the parking space. For example, the reservation holder (user) can set the attribute to be used by operating the mobile terminal 20.

A specific example of the process of step S809 in FIG. 12 will be described with reference to FIG. 13. First, the server device 10 references the database 110 and calculates a distance Xk between a K-th (the initial value of K is one) parking space and the destination, and an index Tk of the easiness of parking in the parking space among the M parking spaces registered in the list in step S805 in FIG. 12 (step S901).

For example, the index Tk of the easiness of parking is calculated by the following general formula.

Tk=a×(area of parking space)+b×(whether or not there is a roof)

Here, a and b are constants acquired based on experiment and represent the weight of a prioritized term. For example, “whether or not there is a roof” is set as one when there is a roof, and zero when there is not a roof.

Then, the server device 10 increments K by one (step S902). When K is less than M+1 (Yes in step S903), the process proceeds to step S901. Otherwise (No in step S903), the process proceeds to step S904.

In step S904, the server device 10 calculates a score S for each of the M parking spaces registered in the list in step S805 in FIG. 12 based on the distance Xk and the index Tk calculated in step S901.

For example, the score S is calculated by the following general formula.

S=c×(value corresponding to distance Xk)+d×Tk

Here, c and d are constants acquired based on experiment and represent the weight of a prioritized term.

For example, “value corresponding to distance Xk” can be set as follows.

When distance from destination is less than 100 m: 10 points

When distance from destination is greater than or equal to 100 m and less than 200 m: 6 points

When distance from destination is greater than or equal to 200 m and less than 300 m: 3 points

When distance from destination is greater than or equal to 300 m: 1 point

Then, in step S905, the server device 10 selects the parking space having the highest score S calculated in step S904 and registers a reservation for the selected parking space as an alternative parking space in the database 110. Then, the process illustrated in FIG. 13 is ended.

### 3.4 Other Examples

While an embodiment of the present disclosure is described thus far with reference to the drawings, the scope of the present disclosure is not limited to the embodiment. It is apparent that those skilled in the art may perceive various modification examples or correction examples within the scope of the idea disclosed in the claims. Those examples also fall within the technical scope of the present disclosure.

For example, the vehicle 30 includes the same hardware configuration as the controller 21, the communication unit 22, the storage unit 23, the operation unit 24, the display unit 25, the camera 26, and the sensor 27 illustrated as the hardware configuration of the mobile terminal 20 in FIG. 1. A combination of such configurations included in the vehicle 30 can be specified as a vehicle-mounted terminal.

A non-transitory computer readable medium storing a program that can execute the processes disclosed in the embodiment can be specified as an aspect of the present disclosure. The non-transitory computer readable medium storing the program of the present disclosure is exemplified by various computer readable media such as an optical disc including a CD-ROM, a magnetic disk, and a semiconductor memory. The program can be installed or loaded on a computer through the computer readable medium or by downloading the program through a communication network and the like.

The destination in the navigation device can be automatically set based on the received information on the second parking space. In such a case, there are variations depending on which device receives the information on the second parking space. For example, when the mobile terminal of the reservation holder receives the information on the second parking space, it is considered that the information on the second parking space is transmitted to the navigation device from the mobile terminal by Bluetooth and the like, and that the navigation device sets the destination based on the received information on the second parking space. It is also considered that the navigation device is set to directly receive the information on the second parking space and sets the destination based on the directly received information on the second parking space.

What is claimed is:

1. A parking management system comprising a processor configured to perform operations, the operations including:
receiving information on illegal parking in a first parking space which is reserved for use;
searching for a parkable second parking space as an alternative for the first parking space based on the information on the illegal parking; and
transmitting information on the second parking space to a device on which the reservation for use is made, or a device that is registered in advance.

2. The parking management system according to claim 1, wherein in the operation of searching, the processor searches for the second parking space based on a distance from the first parking space.

3. The parking management system according to claim 2, wherein in the operation of searching, the processor searches for the second parking space of which the distance from the first parking space is less than a predetermined distance, and determines whether the second parking space is reservable in a reserved time period of the first parking space.

4. The parking management system according to claim 1, wherein in the operation of searching, the processor searches for the second parking space based on a distance from a destination of a user who has the reservation for the first parking space.

5. The parking management system according to claim 4, wherein in the operation of searching, the processor searches for the second parking space of which the distance from the destination of the user having the reservation for the first parking space is less than a predetermined distance, and determines whether the second parking space is reservable in a reserved time period of the first parking space.

6. The parking management system according to claim 1, wherein in the operation of searching, the processor searches for the second parking space based on an attribute of a parking space.

7. The parking management system according to claim 6, wherein in the operation of searching, the processor executes the search for the second parking space a predetermined number of times, and selects the second parking space as an alternative parking space based on a distance from a destination and easiness of parking in the parking space.

8. A parking management method implemented in an information processing device including a processor, the parking management method comprising:
by the processor, receiving information on illegal parking in a first parking space which is reserved for use;
by the processor, searching for a parkable second parking space as an alternative for the first parking space based on the information on the illegal parking; and
by the processor, transmitting information on the second parking space to a device on which the reservation for use is made, or a device that is registered in advance.

9. The parking management method according to claim 8, further comprising:
by the processor, operating a camera to capture an image of the first parking space and reading identification information on the first parking space in accordance with an instruction from an outside; and
by the processor, comparing information on the reservation for using the first parking space with the identification information on the first parking space and receiving identification information on a vehicle illegally parked in the first parking space imaged by the camera when the information on the reservation for using the first parking space matches the identification information on the first parking space.

10. A non-transitory computer readable medium storing a program causing a computer to execute processing, the program comprising steps of
receiving information on illegal parking in a first parking space which is reserved for use,
searching for a parkable second parking space as an alternative for the first parking space based on the information on the illegal parking, and
transmitting information on the second parking space to a device on which the reservation for use is made, or a device that is registered in advance.

11. A parking management system comprising:
a server device with which reservation information on one or a plurality of parking spaces is registered, the server device including a first controller; and
a mobile terminal including
a communication unit configured to communicate with an external device,
a camera configured to capture an image of a parking space and a vehicle parked in the parking space and acquire the captured image, and
a second controller configured to acquire information on the parking space and identification information on the vehicle parked in the parking space from the image, wherein:
the second controller is configured to acquire the reservation information on the parking space from the server device through a communication network, compare the reservation information with the identification information on the vehicle, determine that illegal parking is performed when there is inconsistency in the comparison, and transmit information on the illegal parking to the server device; and
the first controller is configured to search for a parkable second parking space, based on the information on the illegal parking, as an alternative for a first parking space that is a parking space in which the second controller determines that the illegal parking is performed, and transmit information on the second parking space to the mobile terminal or a device that is used when a reservation for using the first parking space is made.
